(19) United States
(12) Patent Application Publication
(10) Pub. No.: US 2006/0250663 A1
(43) Pub. Date: Nov. 9, 2006

(54) CIS scanning apparatus for scanning both reflective and transparent objects

(75) Inventors: Shao-Hwa Wang, Zhong-He (TW); Hsiang-Wen Shiue, Zhong-He (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Asia Tech Image Inc.

(21) Appl. No.: 11/244,366

(22) Filed: Oct. 5, 2005

(30) Foreign Application Priority Data
May 3, 2005 (TW) 094114298

(51) Int. Cl. H04N 1/04

(52) U.S. Cl. 358/474

(57) ABSTRACT

A CIS scanning apparatus capable of scanning both a transparent object (206) and a reflective object (208) is provided, including a printed circuit board; a color light source electrically connected with the PCB and providing color light for illuminating the reflective object from the bottom; a white transparency adapter (207) providing white light for illuminating the transparent object from the top; a long black and white image sensor (203) connected with the PCB and for receiving the light reflected by the reflective object; a short color image sensor (202) connected with the PCB and for receiving the light transmitted by the transparent object; and at least a lens array (204, 205) for focusing the reflected light and transmitted light onto at least one of the black and white image sensor and the color image sensor.

### BACKGROUND OF THE INVENTION

1. Field of the Invention

The present invention relates generally to a scanning apparatus, and more particularly to a contact image sensor (CIS) type scanning apparatus for scanning both reflective and transparent objects.

2. Description of the Prior Art

There are two types of the scanning apparatus dedicated to scanners, facsimiles, and the likes. One is charge-coupled device (CCD), and the other is contact image sensor (CIS). A CIS scanning apparatus is more compact than a CCD scanning apparatus and can be used in smaller products than a CCD scanning apparatus. The CIS scanning apparatus also consume less power than CCD scanning apparatus and often can run on battery power or power from a universal serial bus (USB) port. Therefore, the CIS scanning apparatus are widely used in portable scanners or other micro image reading apparatus.

Earlier black and white CIS scanning apparatus for scanning original documents gather light from red, green, and blue LEDs (light-emitting diodes), which combine to provide white light, and direct the light to the document being scanned. The light that is reflected from the document is gathered by a lens and directed at an image sensor array that rests just under the document being scanned. The sensor then records the image according to the black and white intensity of light that hits the sensor. However, with the development of photographic technology, scanning technology is no longer limited in documents scanning. New types of scanning apparatus applied to films and slides scanning are put forward, which meets the requirement of saving image information.

Conventional CIS scanning apparatus having both reflective and transparent scanning functions generally have the configurations shown in FIGS. 1A to 1C of the attached drawings.

FIG. 1A shows a conventional scanning apparatus, which includes a white transparency adapter 101, a high-density color image sensor 104, and a lens group 103 disposed between the transparency adapter 101 and the high-density color image sensor 104. When the scanning apparatus performs a scanning operation toward an object 102, white light generated by the transparency adapter 101 penetrates the object 102 and focuses on the high-density color image sensor 104 through the lens group 103, thus forming a reduced image of the object 102 on the high-density color image sensor 104. In order to satisfy the focus length of the white light, this scanning apparatus inevitably has a bulk volume.

FIG. 1B shows another conventional scanning apparatus, which includes a white transparency adapter 111 arranged above a platform (not shown) for supporting an object 112, a white light source (not shown) arranged below the platform, a long color image sensor 114, and a lens array 113 disposed between the transparent light source 111 and the color image sensor 114. When the object 112 is a transparent object, such as a film or a slide, white light generated by the transparency adapter 111 penetrates the transparent object 112 and focuses on the color image sensor 114 through the lens array 113, thus forming an image of the transparent object 112 on the color image sensor 114. When the object 112 is a reflective object, such as paper or a document, white light generated by the white light source illuminates the reflective object 112 from the bottom and reflected thereon, and finally arrives to the color image sensor 114 through the lens array 113, thus forming an image of the reflective object 112 on the color image sensor 114. The second conventional scanning apparatus solves the above-mentioned problem of bulk volume of the first conventional scanning apparatus. However, the color image sensor 114 must be long enough to fit the width of the reflective object 112, which increases the cost of the scanning apparatus.

FIG. 1C shows a further conventional scanning apparatus having a similar configuration to the second one, except that the transparency adapter 121 is a color transparency adapter, the image sensor 124 for illuminating the transparent object 122 is adopted a black and white image sensor to reduce the sensor cost, and the light source (not shown) for illuminating the reflective object 122 is a color light source that generates color light. However, this scanning apparatus also faces a problem of high cost due to its expensive color transparency adapter 121. Furthermore, the color transparency adapter 121 is not common used in the market, whose suppliers are difficult to find. Therefore, this scanning apparatus is disadvantageous to be popularized.

Hence, an improved scanning apparatus is required to overcome the above-mentioned disadvantages of the prior arts.

### SUMMARY OF THE INVENTION

Therefore, the objective of the present invention is to provide a scanning apparatus for scanning both reflective and transparent objects which combines the advantages of the conventional scanning apparatus and suitable for popularizing in the market.

In order to achieve the above objective and overcome the above-identified deficiencies in the prior arts, a scanning apparatus in accordance with the present is designed for scanning both a transparent object and a reflective object. The scanning apparatus comprises a printed circuit board; a color light source providing color light for illuminating the reflective object from the bottom; a white transparency adapter providing white light for illuminating the transparent object from the top; a long black and white image sensor for receiving the light reflected by the reflective object; a short color image sensor for receiving the light transmitted by the transparent object; and at least a lens array for focusing the reflected light and transmitted light onto at least one of the black and white image sensor and the color image sensor.

Other objects, advantages, and novel features of the invention will become more apparent from the following detailed description of a preferred embodiment when taken in conjunction with the accompanying drawings.

### BRIEF DESCRIPTION OF THE DRAWINGS

The present invention may best be understood through the following description with reference to the accompanying drawings, in which:

FIG. 1A is a schematic illustration of a conventional scanning apparatus as viewed from the front;

FIG. 1B is a schematic illustration of another conventional scanning apparatus as viewed from the front;

FIG. 1C is a schematic illustration of a further conventional scanning apparatus as viewed from the front; and

FIG. 2 is a schematic illustration of a scanning apparatus in accordance with a preferred embodiment of the present invention, as viewed from the side.

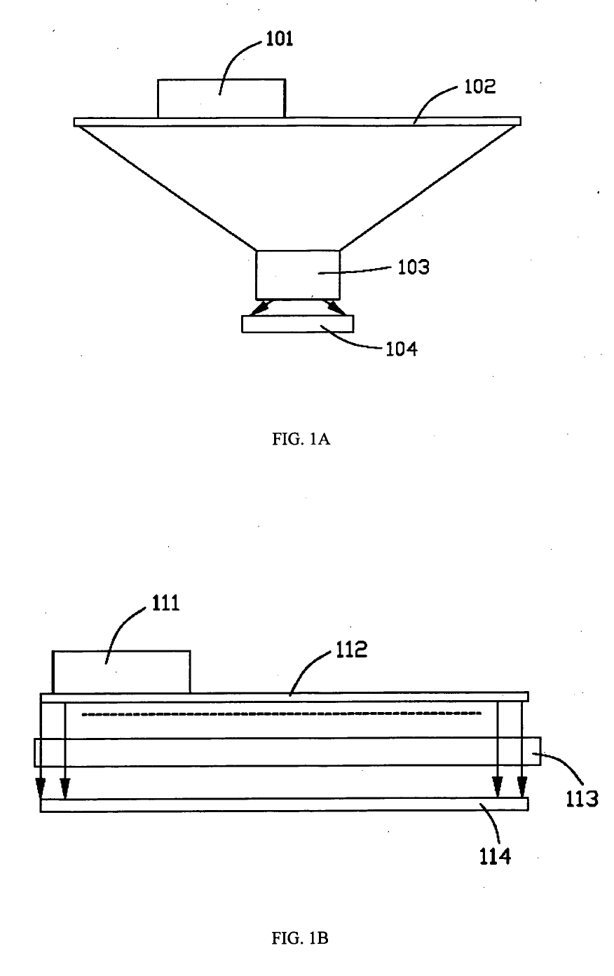

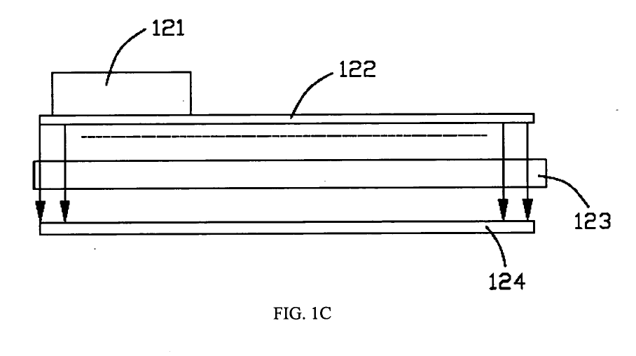

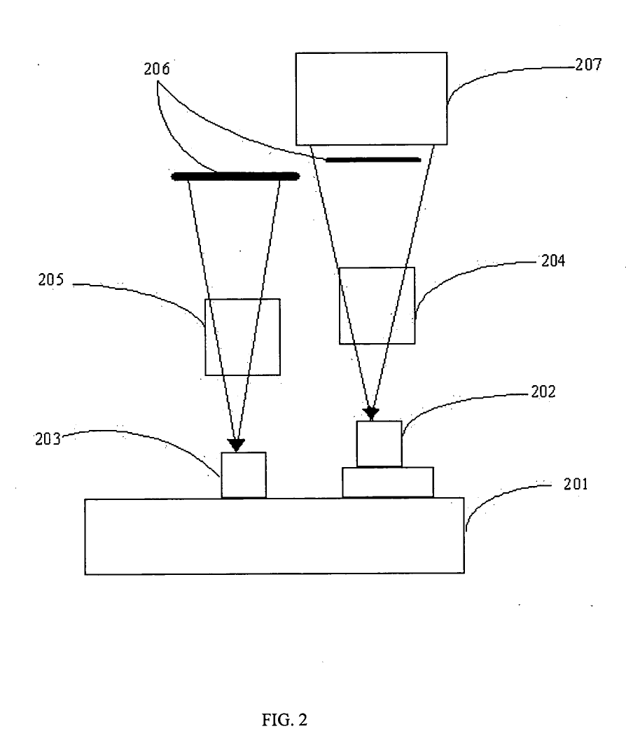

### DETAILED DESCRIPTION OF THE PREFERRED EMBODIMENT

Reference will now be made in detail to a preferred embodiment of the present invention.

Referring to FIG. 2, a scanning apparatus in accordance with a preferred embodiment of the present invention comprises light illuminating means, optical means, sensor means, and signal processing means.

The light illuminating means comprises a white transparency adapter 207 for generating white light to illuminate a transparent object (such as a slide or a film) 206 that is positioned on an original platform (not shown), and a color light source (not shown) composed of a set of red, green and blue LEDs (Light Emitting Diodes) arranged on a light guiding stick for generating color lights to illuminate a reflective object (such as paper or a document) 208 that is positioned on the platform. The white transparency adapter 207 is disposed above the platform and projects white light from the top of the transparent object 206. The color light source is disposed below the platform and projects color light from the bottom of the reflective object 208. The transparent and reflective objects 206, 208 each may have a substantially rectangular shape with a length in a lengthwise direction and a width in a lateral direction.

The optical means comprises a-first lens array 204 for focusing the light generated by the white transparency adapter 207 and penetrating the transparent object 206, and a second lens array 205 for focusing the light generated by the color light source and reflected by the reflective object 208. The first and second lens arrays 204, 205 are substantially parallel to each other and extending lateral direction. In an alternative embodiment, the optical means comprises only one lens array, which substantially combines the first and second lenses 204, 205.

The sensor means comprises a color image sensor 202 extending in the lateral direction, and a black and white image sensor 203 extending parallel to the color image sensor 202. The color image sensor 202 and the black and white image sensor 203 respectively receive the transmitting light and the reflected light from the object 206, 208 to form an object image. The color image sensor 202 and the black and white image sensor 203 are arranged in different focus heights according to different thicknesses of the transparent and reflective objects 206, 208, and so do the first and second lens arrays 204, 205, in order to ensure correct focusing of the object images on the sensors 202, 203. The color image sensor 202 has a length corresponding to the width of the transparent object 206. The black and white image sensor 203 has a length corresponding to the width of the reflective object 208. Accordingly, the color image sensor 202 is usually shorter than the black and white image sensor 203.

The signal processing means comprises a printed circuit board 201 having a processing circuit thereon. The color image sensor 202 and the black and white image sensor 203 are both connected with the processing circuit through which optical image signals collected by the sensor means are converted into digital (electrical) signals. The color light source is electrically connected with the processing circuit.

When the reflective object 208 is scanned, the color light source illuminates color light to a region of the reflective object 208 from the bottom, which covers a row in the lateral direction. The color light is reflected by the reflective object 208 and generates effective optical image signals according to the intensity of the illuminated region. Then the reflected light travels through the second lens array 205 to focus on the black and white image sensor 203. The black and white image sensor 203 receives the optical image signals and forms a color object image of the illuminated region. The processing circuit of the printed circuit board 201 then receives the optical image signals and converts the optical image signals into digital signals for computer processing. The color light source and the image sensor 203 are commonly moved along the lengthwise direction. The reflective object 208 is scanned row by row, thereby forming optical image signals and corresponding digital signals set by set. All sets of digital signals are gathered by a computer. Therefore, the reflective object 208 is converted to an electronic document.

When the transparent object 206 is scanned, the white transparency adapter 207 illuminates white light to a region of the transparent object 207 from the top, which covers a row in the lateral direction. The white light penetrates through the transparent object 206 and generates effective optical image signals according to the intensity of the illuminated region. The light penetrating the transparent object 206 then transmits through the first lens array 204 to focus on the color image sensor 202. The color image sensor 202 receives the optical image signals and forms a color object image of the illuminated region. The processing circuit of the printed circuit board 201 then receives the optical image signals and converts the optical image signals into digital signals for computer processing. The white transparency adapter 207 and the color image sensor 202 are commonly moved along the lengthwise direction. The transparent object 208 is scanned row by row, thereby forming optical image signals and corresponding digital signals set by set. All sets of digital signals are gathered by a computer. Therefore, the transparent object 206 is converted to an electronic document.

The scanning apparatus in accordance with the present invention assembles a short color image sensor 202 and a long black and white image sensor 203 to a common printed circuit board 201, which is suitable for being assembled to most popular scanners in the market. Furthermore, the color image sensor 202 cooperates with the white transparency adapter 207 to scan a reflective object 208, and the black and white image sensor 203 cooperates with the color light source to scan a transparent object 206. The configuration of the scanning apparatus in accordance with the present invention can furthest reduce the cost of the scanning apparatus, comparing with other configurations of the conventional scanning apparatus for scanning both reflective and transparent objects as disclosed in the prior arts. Additionally, the first and second lens arrays 204, 205 are arranged in different focus heights for focusing lights from the transparent object 206 and the reflective object 208, respectively, making the scanning for both the transparent object 206 and the reflective object 208 accurate.

It is to be understood, however, that even though numerous characteristics and advantages of the present invention have been set forth in the foregoing description, together with details of the structure and function of the invention, the disclosure is illustrative only, and changes may be made in detail, especially in matters of material, plating method and manufacturing process within the principles of the invention to the full extent indicated by the broad general meaning of the terms in which the appended claims are expressed.

What is claimed is:

1. A scanning apparatus for scanning both transparent object and reflective object, comprising:
a printed circuit board having a processing circuit;
a color light source electrically connected with the processing circuit and providing color light for illuminating said reflective object;
a white transparency adapter providing white light for illuminating said transparent object;
a black and white image sensor electrically connected with the printed circuit board and receiving the light reflected by the reflective object;
a color image sensor electrically connected with the printed circuit board and receiving the light transmitting through the transparent object; and
at least a lens array for focusing said reflected light and transmitting light onto at least one of the black and white image sensor and the color image sensor.

2. The scanning apparatus as claimed in claim 1, wherein the color image sensor has a length corresponding to a width of the transparent object, and the black and white image sensor has a length corresponding to a width of the reflective object.

3. The scanning apparatus as claimed in claim 1, wherein the color image sensor is arranged parallel to the black and white image sensor.

4. The scanning apparatus as claimed in claim 3, wherein the black and white image sensor extends in a lateral direction, the lateral direction being defined by the width of the reflective object.

5. The scanning apparatus as claimed in claim 3, wherein the color image sensor extends in a lateral direction, the lateral direction being defined by the width of the transparent object.

6. The scanning apparatus as claimed in claim 1, wherein the color image sensor and the black and white image sensor are arranged in different focus heights.

7. The scanning apparatus as claimed in claim 6, wherein the color image sensor is arranged at a position higher than the black and white image sensor.

8. The scanning apparatus as claimed in claim 1, wherein the transparent object and the reflective object are arranged on a single platform, the white transparency adapter and the color light source being respectively positioned above and below the platform.

9. The scanning apparatus as claimed in claim 8, wherein the color light source comprises a light guiding stick, the white transparency adapter projecting light to the transparent object from the top, and the color light source projecting light to the reflective object from the bottom.

10. The scanning apparatus as claimed in claim 1, wherein the at least one lens array comprises two lens arrayes respectively focusing the lights reflected by the reflective object and the light transmitting through the transparent object.

11. The scanning apparatus as claimed in claim 9, wherein the two lens arrays are arranged parallel and at different heights.

12. A scanning apparatus for scanning both transparent object and reflective object, comprising:
light illuminating means that provides light illuminating at least one of the transparent and reflective objects, the light being reflected by or transmitting through said at least one object to generate optical image signals;
sensor means that comprises a black and white image sensor and a color image sensor for selectively receiving the optical image signals to form an object image and;
optical means that focuses said at least one of the reflected and transmitting lights onto the sensor means; and
signal processing means that converts said optical image signals to digital signals.

13. The scanning apparatus as claimed in claim 12, wherein the color image sensor has a length corresponding to a width of the transparent object, and the black and white image sensor has a length corresponding to a width of the reflective object, the color image sensor being shorter than the black and white image sensor.

14. The scanning apparatus as claimed in claim 12, wherein the color image sensor is arranged parallel to the black and white image sensor.

15. The scanning apparatus as claimed in claim 12, wherein the color image sensor and the black and white image sensor are arranged at different focus heights.

16. The scanning apparatus as claimed in claim 15, wherein the color image sensor is arranged at a position higher than the black and white image sensor.

17. The scanning apparatus as claimed in claim 12, wherein the optical means comprises two lens arrays for respectively focusing the lights reflected by the reflective object and the light that transmits through the transparent object.

18. The scanning apparatus as claimed in claim 17, wherein the two lens arrays are arranged parallel and at different heights.

19. The scanning apparatus as claimed in claim 12, wherein the light illuminating means comprises a white transparency adapter projecting white light to the transparent object from the top, and a color light source projecting color light to the reflective object from the bottom.

20. The scanning apparatus as claimed in claim 19, wherein the transparent object and the reflective object are arranged on a single platform, the white transparency adapter and the color light source being respectively positioned above and below the platform.
